(19) United States
(12) Patent Application Publication
(10) Pub. No.: US 2012/0183161 A1
(43) Pub. Date: Jul. 19, 2012

(54) DETERMINING INDIVIDUALIZED HEAD-RELATED TRANSFER FUNCTIONS

(75) Inventors: Markus Agevik, Malmo (SE); Martin Nyström, Horja (SE)

(73) Assignee: SONY ERICSSON MOBILE COMMUNICATIONS AB, Lund (SE)

(21) Appl. No.: 13/203,606

(22) PCT Filed: Sep. 3, 2010
(86) PCT No.: PCT/IB10/53979

§ 371 Date: Aug. 26, 2011

(51) Int. Cl. H04R 5/02; G06K 9/00

(52) U.S. Cl. 381/303; 382/154

(57) ABSTRACT

A device may include capturing images of one or more body parts of a user via a camera, determining a three-dimensional model of the one or more body parts based on the captured images, obtaining a head-related transfer function that is generated based on the three-dimensional model, and storing the head-related transfer function in a memory.

### BACKGROUND

In three-dimensional (3D) audio technology, a pair of speakers (e.g., earphones, in-ear speakers, in-concha speakers, etc.) may realistically emulate sound sources that are located in different places. A digital signal processor, digital-to-analog converter, amplifier, and/or other types of devices may be used to drive each of the speakers independently from one another, to produce aural stereo effects.

### SUMMARY

According to one aspect, a method may include capturing images of one or more body parts of a user via a camera, determining a three-dimensional model of the one or more body parts based on the captured images, obtaining a head-related transfer function that is generated based on the three-dimensional model, and storing the head-related transfer function in a memory.

Additionally, the method may further include sending the head-related transfer function and an audio signal to a second remote device that applies the head-related transfer function to the audio signal.

Additionally, determining the three dimensional model may include performing image recognition to identify, in the captured images, one or more body parts.

Additionally, determining the three-dimensional model may include ending captured images or three-dimensional images to a remote device to select or generate the head-related transfer function at the remote device.

Additionally, the method may further include receiving user input for selecting one of the one or more body parts of the user.

Additionally, the method may further include determining a key, using the key to retrieve a corresponding head-related transfer function from the memory, applying the retrieved head-related transfer function to an audio signal to produce an output signal, and sending the output signal to two or more speakers.

Additionally, determining a key may include obtaining information corresponding to an identity of the user.

Additionally, the method may further include receiving a user selection of the audio signal.

According to another aspect, a device may include transceiver to send information pertaining to a body part of a user to a remote device, receive a head-related transfer function from the remote device, and send an output signal to speakers. Additionally, the device may include a memory to store the head-related transfer function received via the transceiver. Additionally, the device may include a processor. The processor may provide the information pertaining to the body part to the transceiver, retrieve the head-related transfer function from the memory based on an identifier, apply the head-related transfer function to an audio signal to generate the output signal, and provide the output signal to the transceiver.

Additionally, the information pertaining to the body part may include one of images of the body part, the images captured via a camera installed on the device, or a three-dimensional model of the body part, the model obtained from the captured images of the body part.

Additionally, the remote device may be configured to at least one of determine the three-dimensional model of the body part based on the images, or generate the head-related transfer function based on the three-dimensional model of the body part.

Additionally, the remote device may be configured to at least one of select one or more of head-related transfer functions based on a three-dimensional model obtained from the information, obtain a head-related transfer function by generating the head-related transfer function or selecting the head-related transfer function based on the three-dimensional model, or tune an existing head-related transfer function by applying at least one of a finite element method, finite difference method, finite volume method, or boundary element method.

Additionally, the speakers may include a pair of headphones.

Additionally, the body part may include at least one of ears; a head; a torso; a shoulder; a leg; or a neck.

Additionally, the device may include a tablet computer; mobile phone; laptop computer; or personal computer.

Additionally, the processor may be further configured to receive user input that selects the audio signal.

Additionally, the device may further include a three-dimensional (3D) camera that receives images from which the information is obtained.

Additionally, the processor may be further configured to perform image recognition of the body part in the images.

According to yet another aspect, a device may include logic to capture images of a body part, determine a three-dimensional model based on the images, generate a head-related transfer function based on information pertaining to the three-dimensional model, apply the head-related transfer function to an audio signal to generate an output signal, and send the output signal to remote speakers.

Additionally, the device may further include a database to store head-related transfer functions. Additionally, the logic may be further configured to store the head-related transfer function in the database, obtain a key, and retrieve the head-related transfer function from the database using the key.

### BRIEF DESCRIPTION OF THE DRAWINGS

The accompanying drawings, which are incorporated in and constitute part of this specification, illustrate one or more embodiments described herein and, together with the description, explain the embodiments. In the drawings:

FIGS. 1A and 1B illustrate concepts that are described herein;

FIG. 2 shows an exemplary system in which the concepts described herein may be implemented;

FIGS. 3A and 3B are front and rear views of an exemplary user device of FIG. 2;

FIG. 4 is a block diagram of exemplary components of a network device of FIG. 2;

FIG. 5 is a functional block diagram the user device of FIG. 2;

FIG. 6 is a functional block diagram of an exemplary head-related transfer function (HRTF) device of FIG. 2;

FIGS. 7A and 7B illustrate three-dimensional (3D) modeling of a user's head, torso, and/or ears to obtain an individualized HRTF;

FIG. 8 is a flow diagram of an exemplary process for obtaining an individualized HRTF; and

FIG. 9 is a flow diagram of an exemplary process for applying an individualized HRTF.

### DETAILED DESCRIPTION

The following detailed description refers to the accompanying drawings. The same reference numbers in different drawings may identify the same or similar elements. As used herein, the term “body part” may include one or more other body parts.

In the following, a system may drive multiple speakers in accordance with a head-related transfer function (HRTF) for a specific individual (e.g., a user), to generate realistic stereo sound. The system may determine the individualized HRTF by selecting one or more of HRTFs or computing HRTFs (e.g., apply a finite element method (FEM)) based on a three-dimensional (3D) model of the user's body parts (e.g., head, ears, torso, etc.). The system may obtain the 3D model of the user's body part(s) based on images of the user. By applying the individualized HRTFs, the system may generate stereo sounds that better emulate the original sound sources (e.g., more easily perceived by the user as if the sounds are produced by the original sound sources at specific locations in 3D space).

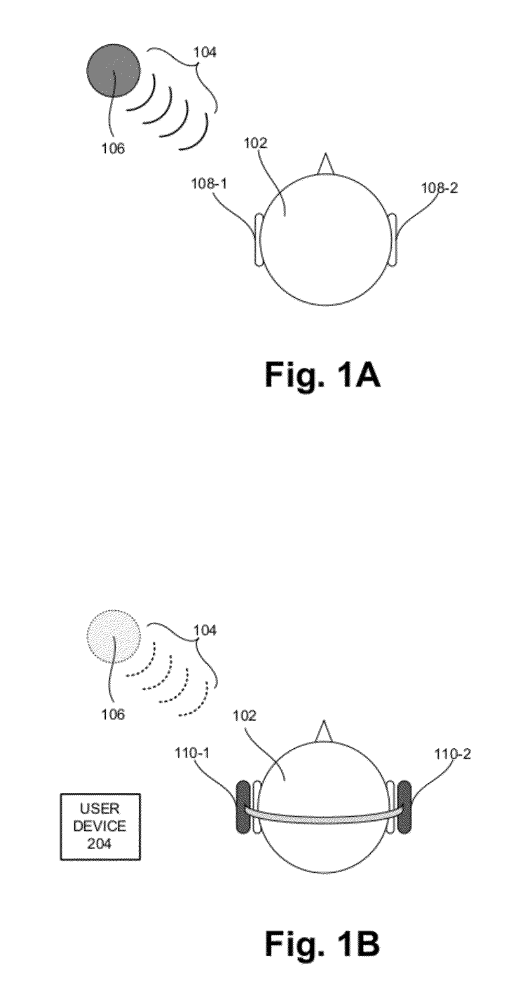

FIGS. 1A and 1B illustrate the concepts described herein. FIG. 1A shows a user 102 listening to a sound 104 that is generated from a source 106. As shown, user 102's left ear 108-1 and right ear 108-2 may receive different portions of sound waves from source 106 for a number of reasons. For example, ears 108-1 and 108-2 may be at unequal distances from source 106, and, consequently, a wave front may arrive at ears 108 at different times. In another example, sound 104 arriving at right ear 108-2 may have traveled different paths than the corresponding sound at left ear 108-1 due to different spatial geometry of objects (e.g., the direction in which ear 108-2 points is different from that of ear 108-1, user 102's head obstructs ear 108-2, different walls facing each of ears 108, etc.). More specifically, for example, portions of sound 104 arriving at right ear 108-2 may be diffracting about head 102 before arriving at ear 108-2.

Assume that the extent of acoustic degradations from source 106 to left ear 108-1 and right ear 108-2 are encapsulated in or summarized by head-related transfer functions H_{L}(ω) and H_{R}(ω), respectively, where ω is frequency. Then, assuming that sound 104 at source 106 is X(ω), the sounds arriving at each of ears 108-1 and 108-2 can be expressed as H_{L}(ω)·X(ω and H_{R}(ω)·X(ω).

FIG. 1B shows a pair of earphones 110-1 and 110-2 that are controlled by a user device 204 within a sound system. Assume that user device 204 causes earphones 110-1 and 110-2 to generate signals G_{L}(ω)·X(ω) and G_{R}(ω)·X(ω), respectively, where G_{L}(ω) and G_{R}(ω) are approximations to H_{L}(ω) and H_{R}(ω). By generating G_{L}(ω)·X(ω) and G_{R}(ω)·X(ω), user device 204 and earphones 110-1 and 110-2 may emulate sound source 106 that is generated from source 106. The more accurately do G_{L}(ω) and G_{R}(ω) approximate H_{L}(ω) and H_{R}(ω), the more accurately user device 204 and earphones 110-1 and 110-2 may emulate sound source 106.

In some implementations, the sound system may obtain G_{L}(ω) and G_{R}(ω) by applying a finite element method (FEM) to an acoustic environment that is defined by the boundary conditions that are specific to a particular individual. Such individualized boundary conditions may be obtained by the sound system by deriving 3D models of user 102's head, user 102's shoulder and torso, etc. based on captured images (e.g., digital images) of user 102. In other implementations, the sound system may obtain G_{L}(ω) and G_{R}(ω) by selecting one or more pre-computed HRTFs based on the 3D models of user 102's head, user 102's shoulder and torso, etc. based on captured images (e.g., digital images) of user 102.

The individualized HRTFs may provide better sound experience for the user to which the HRTFs are tailored than a generic HRTF. A generic HRTF may provide for good 3D sound experience for some users and not-so-good experience for other users.

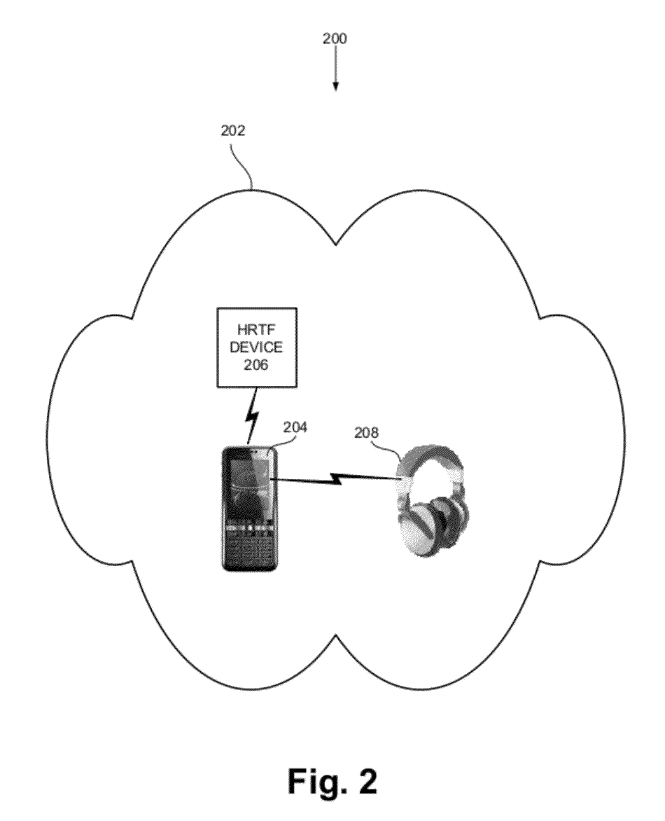

FIG. 2 shows an exemplary system 200 in which concepts described herein may be implemented. As shown, system 200 may include network 202, user device 204, HRTF device 206, and speakers 208.

Network 202 may include a cellular network, a public switched telephone network (PSTN), a local area network (LAN), a wide area network (WAN), a wireless LAN, a metropolitan area network (MAN), personal area network (PAN), a Long Term Evolution (LTE) network, an intranet, the Internet, a satellite-based network, a fiber-optic network (e.g., passive optical networks (PONs)), an ad hoc network, any other network, or a combination of networks. Devices in system 200 may connect to network 202 via wireless, wired, or optical communication links Network 202 may allow any of devices 204 through 208 to communicate with one another.

User device 204 may include any of the following devices with a camera and/or sensors: a personal computer; a tablet computer; a cellular or mobile telephone; a smart phone; a laptop computer; a personal communications system (PCS) terminal that may combine a cellular telephone with data processing, facsimile, and/or data communications capabilities; a personal digital assistant (PDA) that includes a telephone; a gaming device or console; a peripheral (e.g., wireless headphone); a digital camera; a display headset (e.g., a pair of augmented reality glasses); or another type of computational or communication device.

Via user device 204, a user may place a telephone call, text message another user, send an email, etc. In addition, user device 204 may capture images of a user. Based on the images, user device 204 may obtain 3D models that are associated with the user (e.g., 3D model of the user's ears, user's head, user's body, etc.). User device 204 may send the 3D models (i.e., data that describe the 3D models) to HRTF device 206. Alternatively, user device 204 may send the captured images to HRTF device 206. In some implementations, the functionalities of HRTF device 206 may be integrated within user device 204.

HRTF device 206 may receive, from user device 204, images or 3D models that are associated with a user. In addition, HRTF device 206 may select, derive, or generate individualized HRTFs for the user based on the images or 3D models. HRTF device 206 may send the individualized HRTFs to user device 204.

When user device 204 receives HRTFs from HRTF device 206, user device 204 may store them in a database. In some configurations, when user device 204 receives a request to apply a HRTF (e.g., from a user), user device 204 may select, from the database, a particular HRTF (e.g., a pair of HRTFs) that corresponds to the user. User device 204 may apply the selected HRTF to an audio signal (e.g., from an audio player, radio, etc.) to generate an output signal. In other configurations, user device 204 may provide conventional audio signal processing (e.g., equalization) to generate the output signal. User device 204 may provide the output signal to speakers 208.

User device 204 may include an audio signal component that may provide audio signals, to which user device 204 may apply a HRTF. In some configurations, the audio signal component may pre-process the signal so that user device 204 can apply a HRTF to the pre-processed signal. In other configurations, the audio signal component may provide an audio signal to user device 204, so that user device 204 can perform conventional audio signal processing.

Speakers 208 may generate sound waves in response to the output signal received from user device 204. Speakers 208 may include headphones, ear buds, in-ear speakers, in-concha speakers, etc.

Depending on the implementation, system 200 may include additional, fewer, different, and/or a different arrangement of components than those illustrated in FIG. 2. For example, in one implementation, a separate device (e.g., an amplifier, a receiver-like device, etc.) may apply a HRTF generated from HRTF device 206 to an audio signal to generate an output signal. The device may send the output signal to speakers 208. In another implementation, system 200 may include a separate device for generating an audio signal to which a HRTF may be applied (e.g., a compact disc player, a digital video disc (DVD) player, a digital video recorder (DVR), a radio, a television, a set-top box, a computer, etc.). Although network 202 may include other types of network elements, such as routers, bridges, switches, gateways, servers, etc., for simplicity, these devices are not illustrated in FIG. 2.

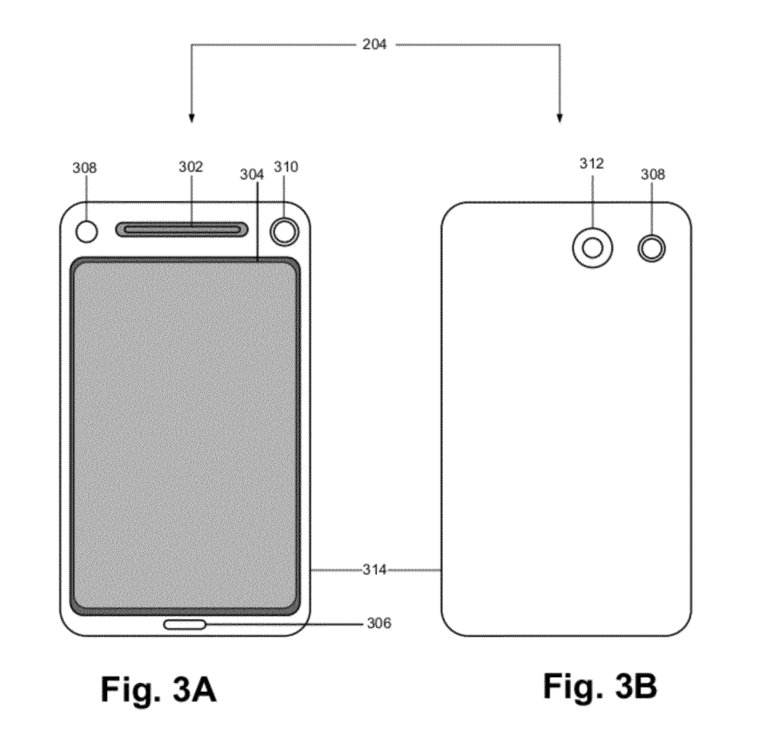

FIGS. 3A and 3B are front and rear views, respectively, of user device 204 according to one implementation. In this implementation, user device 204 may take the form of a smart phone (e.g., a cellular phone). As shown in FIGS. 3A and 3B, user device 204 may include a speaker 302, display 304, microphone 306, sensors 308, front camera 310, rear camera 312, and housing 314. Depending on the implementation, user device 204 may include additional, fewer, different, or different arrangement of components than those illustrated in FIGS. 3A and 3B.

Speaker 302 may provide audible information to a user of user device 204. Display 304 may provide visual information to the user, such as an image of a caller, video images received via cameras 310/312 or a remote device, etc. In addition, display 304 may include a touch screen via which user device 204 receives user input. The touch screen may receive multi-touch input or single touch input.

Microphone 306 may receive audible information from the user and/or the surroundings. Sensors 308 may collect and provide, to user device 204, information (e.g., acoustic, infrared, etc.) that is used to aid the user in capturing images or to provide other types of information (e.g., a distance between user device 204 and a physical object).

Front camera 310 and rear camera 312 may enable a user to view, capture, store, and process images of a subject in/at front/back of user device 204. Front camera 310 may be separate from rear camera 312 that is located on the back of user device 204. In some implementations, user device 204 may include yet another camera at either the front or the back of user device 204, to provide a pair of 3D cameras on either the front or the back. Housing 314 may provide a casing for components of user device 204 and may protect the components from outside elements.

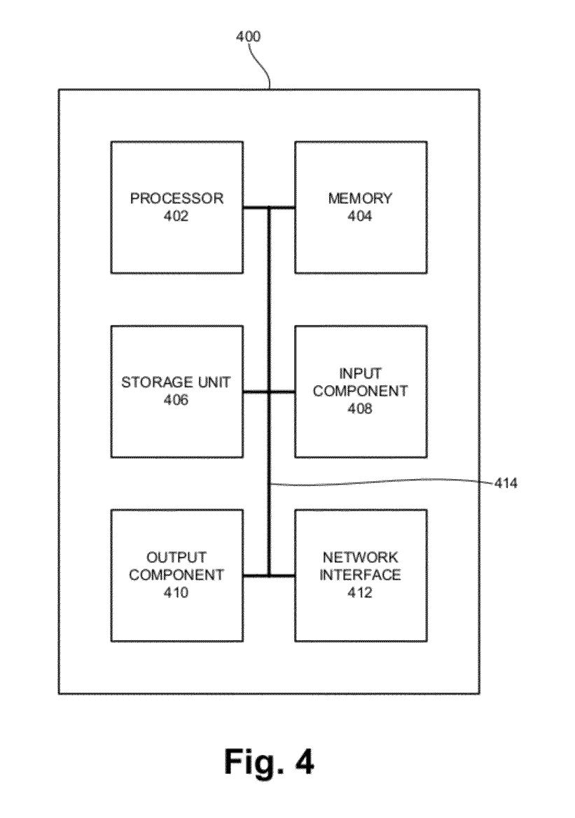

FIG. 4 is a block diagram of exemplary components of network device 400. Network device 400 may represent any of devices 204 through 208 in FIG. 2. As shown in FIG. 4, network device 400 may include a processor 402, memory 404, storage unit 406, input component 408, output component 410, network interface 412, and communication path 414.

Processor 402 may include a processor, a microprocessor, an Application Specific Integrated Circuit (ASIC), a Field Programmable Gate Array (FPGA), and/or other processing logic (e.g., audio/video processor) capable of processing information and/or controlling network device 400.

Memory 404 may include static memory, such as read only memory (ROM), and/or dynamic memory, such as random access memory (RAM), or onboard cache, for storing data and machine-readable instructions. Storage unit 406 may include storage devices, such as a floppy disk, CD ROM, CD read/write (R/W) disc, hard disk drive (HDD), flash memory, as well as other types of storage devices.

Input component 408 and output component 410 may include a display screen, a keyboard, a mouse, a speaker, a microphone, a Digital Video Disk (DVD) writer, a DVD reader, Universal Serial Bus (USB) port, and/or other types of components for converting physical events or phenomena to and/or from digital signals that pertain to network device 400.

Network interface 412 may include a transceiver that enables network device 400 to communicate with other devices and/or systems. For example, network interface 412 may communicate via a network, such as the Internet, a terrestrial wireless network (e.g., a WLAN), a cellular network, a satellite-based network, a wireless personal area network (WPAN), etc. Network interface 412 may include a modem, an Ethernet interface to a LAN, and/or an interface/connection for connecting network device 400 to other devices (e.g., a Bluetooth interface).

Communication path 414 may provide an interface through which components of network device 400 can communicate with one another.

In different implementations, network device 400 may include additional, fewer, or different components than the ones illustrated in FIG. 4. For example, network device 400 may include additional network interfaces, such as interfaces for receiving and sending data packets. In another example, network device 400 may include a tactile input device.

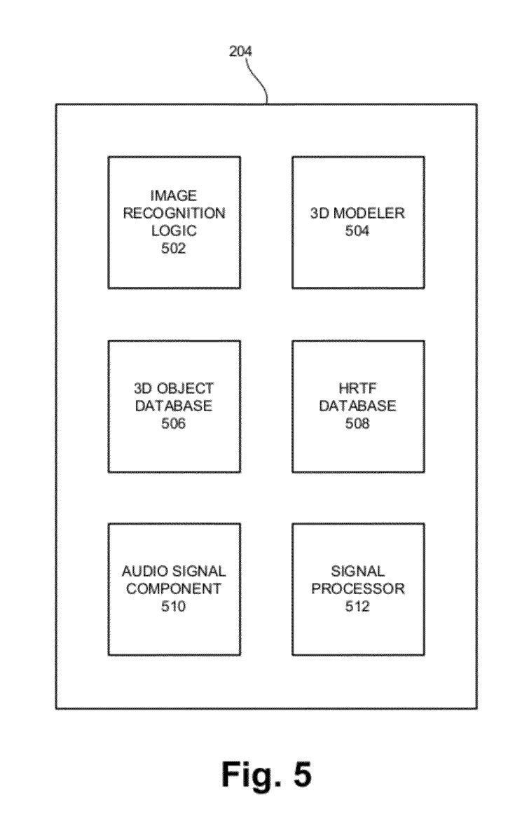

FIG. 5 is a block diagram of exemplary functional components of user device 204. As shown, user device 204 may include image recognition logic 502, 3D modeler 504, 3D object database 506, HRTF database 508, audio signal component 510, and signal processor 512. All or some of the components illustrated in FIG. 5 may be implemented by processor 402 executing instructions stored in memory 404 of user device 204.

Depending on the implementation, user device 204 may include additional, fewer, different, or a different arrangement of functional components than those illustrated in FIG. 5. For example, user device 204 may include an operating system, applications, device drivers, graphical user interface components, communication software, etc. In another example, depending on the implementation, image recognition logic 502, 3D modeler 504, 3D object database 506, HRTF database 508, audio signal component 510, and/or signal processor 512 may be part of a program or an application, such as a game, document editor/generator, utility program, multimedia program, video player, music player, or another type of application.

Image recognition logic 502 may recognize objects in images that are received, for example, via front/rear camera 310/312. For example, image recognition logic 502 may recognize one or more faces, ears, nose, limbs, other body parts, different types of furniture, doors, and/or other objects in images. Image recognition logic 502 may pass the recognized images and/or identities of the recognized images to another component, such as, for example, 3D modeler 504.

3D modeler 504 may obtain identities or 3D images of objects that are recognized by image recognition logic 502, based on information from image recognition logic 502 and/or 3D object database 506. Furthermore, based on the recognized objects, 3D modeler 504 may infer or obtain parameters that characterize the recognized objects.

For example, image recognition logic 502 may recognize a user's face, nose, ears, eyes, pupils, lips, etc. Based on the recognized objects, 3D modeler 504 may retrieve a 3D model of the head from 3D object database 506. Furthermore, based on the received images and the retrieved 3D model, 3D modeler 504 may infer parameters that characterize the model of the user's head, such as, for example, dimensions/shape of the head, etc. Once 3D modeler 504 determines the parameters of the recognized 3D object(s), 3D modeler 504 may generate information that characterize the 3D model(s) and provide the information to another component or device (e.g., HRTF device 206).

3D object database 506 may include data are associated with images of human head, noses, ears, shoulders, torsos, objects (e.g., pieces of furniture, walls, etc.), etc. Based on the data, image recognition logic 502 may recognize objects in images.

In addition, 3D object database 506 may include data that partly defines surfaces of heads, ears, noses, shoulders, torsos, legs, etc. As explained above, 3D modeler 504 may obtain, from the captured images via image recognition logic 502, parameters that, together with the data, characterize the 3D models (i.e., surfaces of the objects in 3D space, a dimension of the object, etc.).

HRTF database 508 may receive HRTFs from another component or device (e.g., HRTF device 206) and store records of HRTFs and corresponding identifiers that are received from a user or other devices. Given a key (i.e., an identifier), HRTF database 508 may search its records for a corresponding HRTF.

Audio signal component 510 may include an audio player, radio, etc. Audio signal component may generate an audio signal and provide the signal to signal processor 512. In some configurations, audio signal component 510 may provide audio signals to which signal processor 512 may apply a HRTF and/or other types of signal processing. In other configurations, audio signal component 510 may provide audio signals to which signal processor 512 may apply only conventional signal processing.

Signal processor 512 may apply a HRTF retrieved from HRTF database 508 to an audio signal that is input from audio signal component 510 or a remote device, to generate an output signal. In some configurations (e.g., selected via user input), signal processor 512 may also apply other types of signal processing (e.g., equalization), with or without a HRTF, to the audio signal. Signal processor 512 may provide the output signal to another device, for example, such as speakers 208.

In some implementations, user device 204 may send the captured images (e.g., 2D or 3D images) to HRTF device 206 rather than sending a 3D model, offloading the 3D modeling process or HRTF selection process based in the captured images to HRTF device 206.

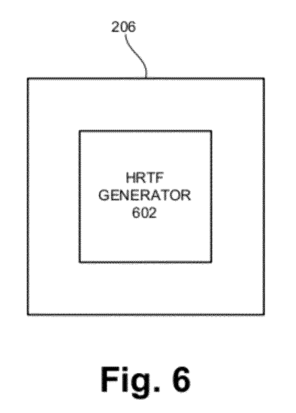

FIG. 6 is a functional block diagram of HRTF device 206. As shown, HRTF device 206 may include HRTF generator 602. In some implementation, HRTF generator 602 may be implemented by processor 402 executing instructions stored in memory 404 of user device 204. In other implementations, HRTF generator 602 may be implemented in hardware.

HRTF generator 602 may receive captured images or information pertaining to 3D models from user device 204. In cases where HRTF generator 602 receives the captured images rather than 3D models, HRTF generator 602 may obtain the information pertaining to the 3D models based on the captured images.

HRTF generator 602 may select HRTFs, generate HRTFs, or obtain parameters that characterize the HRTFs based on information received from user device 204. In implementations or configurations in which HRTF generator 602 selects the HRTFs, HRTF generator 602 may include pre-computed HRTFs. HRTF generator 502 may use the received information (e.g., images captured by user device 204 or 3D models) to select one or more of the pre-computed HRTFs. For example, HRTF generator 602 may characterize a 3D model of a head as large (as opposed to medium or small), having an egg-like shape (e.g., as opposed to circular or elliptical). Based on these characterizations, HRTF generator 602 may select one or more of the pre-computed HRTFs.

In some implementations, HRTF generator 602 may use a 3D model of another body part (e.g., a torso) to further narrow down its selection of HRTFs to a specific HRTF. Alternatively, HRTF generator 602 may refine or calibrate (i.e., pin down values of coefficients or parameters) the selected HRTFs. In these implementations, the selected and/or calibrated HRTFs are the individualized HRTFs provided by HRTF generator 602.

In some configurations or implementations, HRTF generator 602 may compute the HRTFs or HRTF related parameters. In these implementations, HRTF generator 602 may apply, for example, a finite element method (FEM), finite difference method (FDM), finite volume method, and/or another numerical method, using the 3D models as boundary conditions.

Once HRTF generator 602 generates HRTFs, HRTF generator 602 may send the generated HRTFs (i.e., or parameters that characterize transfer functions (e.g., coefficients of rational functions)) to another device (e.g., user device 204).

Depending on the implementation, HRTF device 206 may include additional, fewer, different, or different arrangement of functional components than those illustrated in FIG. 6. For example, HRTF device 206 may include an operating system, applications, device drivers, graphical user interface components, databases (e.g., a database of HRTFs), communication software, etc.

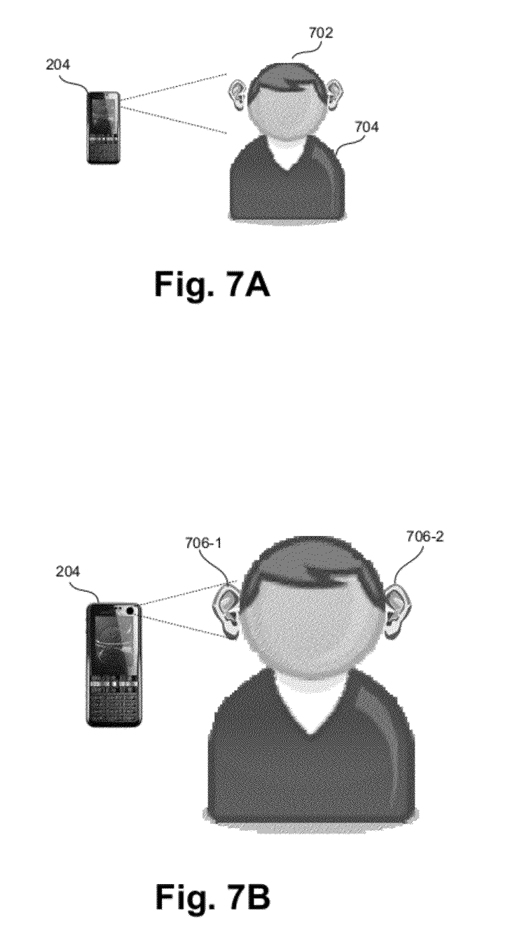

FIGS. 7A and 7B illustrate 3D modeling of a user's head, torso, and/or ears to obtain an individualized HRTF. FIG. 7A illustrates 3D modeling of the user's head 702. As shown, the user device 204 may capture images of head 702 and/or shoulder 704 from many different angles and distances. Based on the captured images, user device 204 may determine a 3D model of head 702 and shoulders 704. FIG. 7B illustrates 3D modeling of the user's ears 706-1 and 706-2.

In some implementations, system 200 may obtain an individualized or personalized HRTF by using 3D models that are sent from user device 204 with a generic 3D model (e.g., a generic model of user's head). For example, assume that user device 204 sends the 3D models of user's ears 706-1 and 706-2 to HRTF device 206. In response, HRTF device 206 may refine a generic HRTF by using the 3D models of ears 706, to obtain the individualized HRTF. The individualized HRTFs may account for the shape of ears 706-1 and 706-2. Generally, individualization of an HRTF may depend on details of the 3D models user device 204 sends to HRTF device 206.

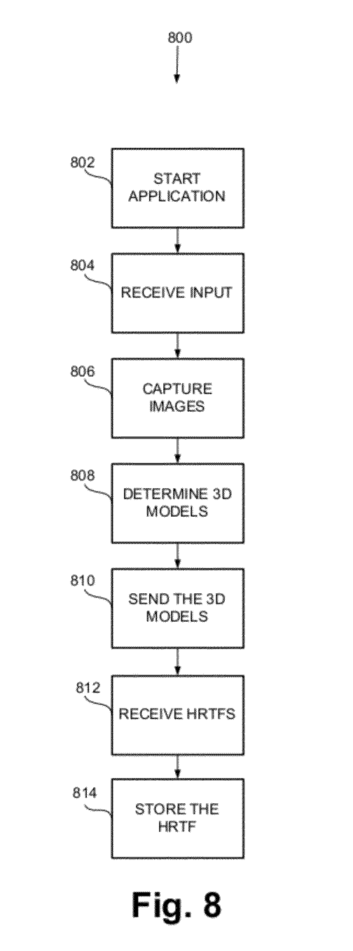

FIG. 8 is a flow diagram of an exemplary process 800 for obtaining an individualized HRTF. As shown, process 800 may begin by starting an application for acquiring 3D models on user device 204 (block 802). The application may interact with the user to captures images of the user and/or obtain 3D models that are associated with the user. Thereafter, the application may send the captured images or the 3D models to HRTF device 206, receive a HRTF from HRTF device 206, and store the HRTF in HRTF database 508.

User device 204 may receive user input (block 804). Via a GUI on user device 204, the user may provide, for example, an identifier (e.g., a user id), designate what 3D models are to be acquired/generated (e.g., user's head, user's ears, torso, etc.), and/or input other information that is associated with the HRTF to be generated at HRTF device 206.

User device 204 may capture images for determining 3D models (block 806). For example, the user may, via camera 310 on user device 204, capture images of the user's head, ears, torso, etc., and/or any object whose 3D model is to be obtained/generated by user device 204. In one implementation, the user may capture images of the object, whose 3D model is to be acquired, from different angles and distances from user device 204. In some implementations, user device 204 may use sensors 308 to obtain additional information, such as distance information (e.g., the distance from user device 204 to the user's face, nose, ears, etc.) to facilitate the generation of 3D models.

User device 204 may determine 3D models based on the captured images (block 808). As discussed above, image recognition logic 502 in user device 504 may identify objects in the captured images. 3D modeler 504 in user device 204 may use the identifications to retrieve and/or complete 3D models that are associated with the images. In some implementations, user device 204 may off-load the acquisition of 3D models or associated parameters to another device (e.g., HRTF device 206) by sending the captured images to HRTF device 206.

User device 204 may send the 3D models to HRTF device 206 (block 810). When HRTF device 206 receives the 3D models, HRTF device 206 may generate HRTFs via, for example, a numerical technique (e.g., the FEM) as described above, or select a set of HRTFs from pre-computed HRTFs. HRTF device 206 may send the generated HRTFs to user device 204. In cases where HRTF device 206 receives the captured images from user device 204, HRTF device 206 may generate the 3D model or the information pertaining to the 3D model based on the received imaged.

User device 204 may receive the HRTFs from HRTF device 206 (block 812). When user device 204 receives the HRTFs, user device 204 may associate the HRTFs with a particular user, identifiers (e.g., user id), and/or user input (see block 804), and store the HRTFs along with the associated information, in HRTF database 508 (block 814).

In some implementations, user device 204 may include sufficient computational power to generate the HRTFs. In such instances, acts that are associated with blocks 810 and 812 may be omitted. Rather, user device 204 may generate the HRTFs based on the 3D models.

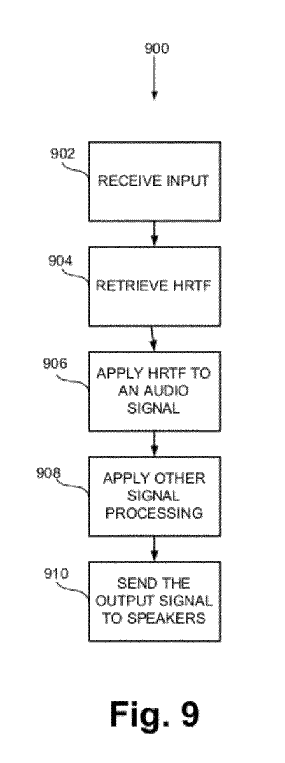

FIG. 9 is a flow diagram of an exemplary process 900 for applying an individualized HRTF. As shown, an application (e.g., a 3D sound application) may receive user input (block 902). For example, in one implementation, an application may receive a user selection of an audio signal (e.g., music, sound effect, voice mail, etc.). In some implementations, the application may automatically determine whether a HRTF may be applied to the selected sound. In other implementations, the user may specifically request that the HRTF be applied to the selected sound.

User device 204 may retrieve HRTFs from HRTF database 508 (block 904). In retrieving the HRTFs, user device 204 may use an identifier that is associated with the user as a key for a database lookup (e.g., a user id, identifier in a subscriber identifier module (SIM), a telephone number, account number, etc.). In some implementations, user device 204 may perform face recognition of the user to obtain an identifier that corresponds to the face.

User device 204 may apply the HRTFs to an audio signal (e.g., an audio signal that includes signals for left and right ears) selected at block 902 (block 906). In addition, user device 204 may apply other types of signal processing to the audio signal to obtain an output signal (block 908). The other types of signal processing may include signal amplification, decimation, interpolation, digital filtering (e.g., digital equalization), etc.

At block 910, user device 204 may send the output signal to speakers 208.

### Conclusion

The foregoing description of implementations provides illustration, but is not intended to be exhaustive or to limit the implementations to the precise form disclosed. Modifications and variations are possible in light of the above teachings or may be acquired from practice of the teachings.

For example, in the above, user device 204 is described as applying an HRTF to an audio signal. In some implementations, user device 204 may off-load such computations to one or more remote devices (e.g., cloud computing). The one or more remote devices may then send the processed signal to user device 204 to be relayed to speakers 208, or, alternatively, send the processed signal directly to speakers 208.

In another example, in the above, speakers 208 are illustrated as a pair of headphones. In other implementations, speakers 208 may include sensors for detecting motion of the user's head. In these implementations, user device 204 may use the measured movement of the user's head (e.g., rotation) to dynamically modify the HRTF and to alter sounds that are delivered to the user (e.g., change the simulated sound of a passing car as the user's head rotates).

In still yet another example, in the above, user device 204 is described as providing HRTF device 206 with information pertaining to 3D models. The information may be obtained by processing images that are received at camera 310 of user device 204. In other implementations, user device 204 may provide HRTF device 206 with other types of information, such as distance information, speaker volume information, etc., obtained via sensors 308, microphone 306, etc. Such information may be used to determine, tune and/or calibrate the HRTF. The tuning or calibration may be performed at either HRTF device 206 and/or user device 204.

In the above, while series of blocks have been described with regard to the exemplary processes, the order of the blocks may be modified in other implementations. In addition, non-dependent blocks may represent acts that can be performed in parallel to other blocks. Further, depending on the implementation of functional components, some of the blocks may be omitted from one or more processes.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A method comprising:
capturing images of one or more body parts of a user via a camera;
determining a three-dimensional model of the one or more body parts based on the captured images;
obtaining a head-related transfer function that is generated based on the three-dimensional model; and
storing the head-related transfer function in a memory.

2. The method of claim 1, further comprising:
sending the head-related transfer function and an audio signal to a remote device that applies the head-related transfer function to the audio signal.

3. The method of claim 2, wherein determining the three dimensional model includes:
performing image recognition to identify, in the captured images, one or more body parts.

4. The method of claim 1, wherein determining the three-dimensional model includes:
sending captured images or three-dimensional images to a remote device to select or generate the head-related transfer function at the remote device.

5. The method of claim 1, further comprising:
receiving user input for selecting one of the one or more body parts of the user.

6. The method of claim 1, further comprising:
determining a key;
using the key to retrieve a corresponding head-related transfer function from the memory;
applying the retrieved head-related transfer function to an audio signal to produce an output signal; and
sending the output signal to two or more speakers.

7. The method of claim 6, wherein determining a key includes:
obtaining information corresponding to an identity of the user.

8. The method of claim 6, further comprising:
receiving a user selection of the audio signal.

9. A device comprising:
transceiver to:
send information pertaining to a body part of a user to a remote device,
receive a head-related transfer function from the remote device, and
send an output signal to speakers;
a memory to:
store the head-related transfer function received via the transceiver; and
a processor to:
provide the information pertaining to the body part to the transceiver,
retrieve the head-related transfer function from the memory based on an identifier,
apply the head-related transfer function to an audio signal to generate the output signal, and
provide the output signal to the transceiver.

10. The device of claim 9, wherein the information pertaining to the body part includes one of:
images of the body part, the images captured via a camera installed on the device; or
a three-dimensional model of the body part, the model obtained from the captured images of the body part.

11. The device of claim 10, wherein the remote device is configured to at least one of:
determine the three-dimensional model of the body part based on the images; or
generate the head-related transfer function based on the three-dimensional model of the body part.

12. The device of claim 10, wherein the remote device is configured to at least one of:
select one or more of head-related transfer functions based on a three-dimensional model obtained from the information;
obtain a head-related transfer function by generating the head-related transfer function or selecting the head-related transfer function based on the three-dimensional model; or
tune an existing head-related transfer function by applying at least one of a finite element method, finite difference method, finite volume method, or boundary element method.

13. The device of claim 9, wherein the speakers include a pair of headphones.

14. The device of claim 9, wherein the body part includes at least one of:
ears; a head; a torso; a shoulder; a leg; or a neck.

15. The device of claim 9, wherein the device comprises:
a tablet computer; mobile phone; laptop computer; or personal computer.

16. The device of claim 9, wherein the processor is further configured to:
receive user input that selects the audio signal.

17. The device of claim 9, further comprising:
a three-dimensional (3D) camera that receives images from which the information is obtained.

18. The device of claim 9, wherein the processor is further configured to:
perform image recognition of the body part in the images.

19. A device comprising:
logic to:
capture images of a body part;
determine a three-dimensional model based on the images;
generate a head-related transfer function based on information pertaining to the three-dimensional model;
apply the head-related transfer function to an audio signal to generate an output signal; and
send the output signal to remote speakers.

20. The device of claim 19, further comprising a database to store head-related transfer functions, wherein the logic is further configured to:
store the head-related transfer function in the database;
obtain a key; and
retrieve the head-related transfer function from the database using the key.
